(19) United States
(12) Patent Application Publication
(10) Pub. No.: US 2026/0110935 A1
(43) Pub. Date: Apr. 23, 2026

(54) DISPLAY MODULE AND ELECTRONIC PAPER

(71) Applicant: HKC CORPORATION LIMITED, Shenzhen (CN)

(72) Inventors: Junhao Luo, Shenzhen (CN); Haijiang Yuan, Shenzhen (CN)

(21) Appl. No.: 19/344,443

(22) Filed: Sep. 29, 2025

(30) Foreign Application Priority Data
Oct. 21, 2024 (CN) 202411466661.3

(51) Int. Cl. G02F 1/1335; G02F 1/167; G02F 1/1677

(52) U.S. Cl. CPC G02F 1/133512; G02F 1/133514; G02F 1/167; G02F 1/1677

(57) ABSTRACT

The present application provides a display module and an electronic paper. The display module includes: a base layer made of opaque material, a color film layer arranged on the base layer, and a color adjustment assembly connected to the color film layer; the color film layer includes a black matrix layer and a plurality of color resistant units arranged on the base layer, the black matrix layer is provided with a plurality of positioning holes, the plurality of color resistant units are arranged in the plurality of positioning holes, wherein at least two of the plurality of color resistant units have different colors, any one of the plurality of color resistant units is correspondingly provided with the color adjustment assembly, wherein each color adjustment assembly is respectively configured to adjust a display chromaticity of each of the plurality of color resistant units to an external environment.

### CROSS REFERENCE TO RELATED APPLICATION

Pursuant to 35 U.S.C. § 119 and the Paris Convention Treaty, the present application claims the benefit of Chinese Patent Application No. 202411466661.3 filed Oct. 21, 2024, the contents of which are incorporated herein by reference.

### TECHNICAL FIELD

The present application relates to the technical field of an electronic paper technology, and more particularly to a display module and an electronic paper.

### BACKGROUND

The electronic paper display technology has been widely used in commercial applications recently. Black and white electronic paper screens are used everywhere, and they are favored because of their advantages such as energy saving, anti-glare and clear readability. However, most of the existing mainstream commercial electronic paper products are limited to black and white display, and only a small number of three-color electronic papers have been launched, and most of them use electrophoresis technology.

However, the main defect of electronic paper using electrophoresis technology is that each pixel can only display a limited two or three state colors, the color reproduction ability is poor, and the display effect is not good.

### SUMMARY

An objective of the embodiment of the present application is to provide a display module, which aims to solve the problem of how to improve the display effect and reduce energy consumption.

In order to achieve the above-mentioned objective, the technical solution adopted by the present application is that:

In a first aspect, a display module is provided, which includes: a base layer made of opaque material, a color film layer arranged on the base layer, and a color adjustment assembly connected to the color film layer, the color film layer includes a black matrix layer and a plurality of color resistant units arranged on the base layer, the black matrix layer is provided with a plurality of positioning holes, the plurality of color resistant units are arranged in the plurality of positioning holes, wherein at least two of the plurality of color resistant units have different colors, any one of the plurality of color resistant units is correspondingly provided with the color adjustment assembly, wherein each color adjustment assembly is respectively configured to adjust a display chromaticity of each of the plurality of color resistant units to an external environment.

In some embodiments, the color adjustment assembly includes a magnetic fluid layer made of opaque material, a driving member capable of generating a magnetic field and configured to control the magnetic fluid layer to move, and a controller configured to control a magnetic field strength of the driving member; and the driving member drives the magnetic fluid layer to move to adjust a coverage area of the magnetic fluid layer covering the plurality of color resistant units.

In some embodiments, the driving member is a first coil formed by spirally winding a wire and in a planar shape, the first coil is arranged relative to a color display surface of one color resistant unit, the first coil is provided with a first power connection point and a second power connection point, the first power connection point and the second power connection point are respectively located at two end points of the wire, and the first power connection point is located at a central position of the first coil.

In some embodiments, the first coil is further provided with a third power connection point, and the third power connection point is located between the first power connection point and the second power connection point.

In some embodiments, the color adjustment assembly further includes a first receiving shell made of transparent material and arranged relative to the color resistant unit, the first receiving shell is provided with a first receiving cavity configured to receive the magnetic fluid layer.

In some embodiments, the first receiving shell protrudes toward the color resistant unit and the color resistant unit is recessed in a direction away from the first receiving cavity, the first coil is recessed and a recessed direction of the first coil is the same as a recessed direction of the color resistant unit.

In some embodiments, the color adjustment assembly further includes a reflective layer disposed on the first receiving shell, and the reflective layer is configured to reflect an external light to the color resistant unit.

In some embodiments, he driving member is an electromagnet located in the black matrix layer, the electromagnet is provided with a second coil, the second coil is spirally wound along a circumference direction of a fixed axis and extends along an axial direction of the fixed axis, the axial direction of the fixed axis is parallel to the base layer, the black matrix layer is provided with a receiving hole corresponding to a position of the driving member, a part of the magnetic fluid layer is stored in the receiving hole, and another part of the magnetic fluid layer covers the color resistant unit, and the driving member drives the magnetic fluid layer to flow from the receiving hole to the color resistant unit, or drives the magnetic fluid layer to flow from the color resistant unit into the receiving hole.

In some embodiments, the color adjustment assembly further includes a second receiving shell made of transparent material, the second receiving shell covers the color resistant unit and is provided with a second receiving cavity configured to receive the magnetic fluid layer, and the second receiving cavity is connected to the receiving hole.

In a second aspect, an electronic paper is provided, which includes the display module.

The beneficial effects of the present application are:

The display module includes the base layer, the color film layer and the color adjustment assembly. The color film layer includes the black matrix layer and the plurality of color resistant units. Through the control and color adjustment of each color resistant unit by each color adjustment assembly, the human eye can see the color resistant units with different display chromaticity, and finally the display module can display high color chromaticity. The display module only need to use ambient light, without backlight, to make the picture clearly displayed, which can save a lot of power consumption, and increase the display quantity of color chromaticity, and also improve the display contrast.

### BRIEF DESCRIPTION OF THE DRAWINGS

FIG. 1 is a schematic diagram of the structural principle of a display module provided by an embodiment of the present application;

FIG. 2 is a schematic diagram of the principle of a first coil of the display module of FIG. 1;

FIG. 3 is a schematic diagram of the structural principle of a display module provided by another embodiment of the present application;

FIG. 4 is a schematic diagram of the principle of a magnetic fluid layer of the display module of FIG. 3 in a state of aggregation and contraction;

FIG. 5 is a schematic diagram of the structural principle of a display module provided by another embodiment of the present application;

FIG. 6 is a schematic diagram of a three-dimensional structure of a second coil of FIG. 5; and

FIG. 7 is a schematic diagram of the structural principle of a display module provided by another embodiment of the present application.

The reference numerals in the Drawings are listed as following:

10—base layer; 20—color film layer; 21—black matrix layer; 22—color resistant unit; 30-color adjustment assembly; 31—electromagnet; 32—magnetic fluid layer; 41—second receiving shell; 42—second receiving cavity; 211—positioning hole; 43—receiving hole; 51—first receiving shell; 511—first receiving cavity; 60—first coil; 311—second coil; 61—first power connection point; 62-second power connection point; 63—third power connection point; and 53—reflective layer.

### DESCRIPTION OF THE EMBODIMENTS

In order to make the purpose, the technical solution and the advantages of the present application be clearer and more understandable, the present application will be further described in detail below with reference to accompanying figures and embodiments. It should be understood that the specific embodiments described herein are merely intended to illustrate but not to limit the present application.

It is noted that when a component is referred to as being “fixed to” or “disposed on” another component, it can be directly or indirectly on another component. When a component is referred to as being “connected to” another component, it can be directly or indirectly connected to another component. The terms such as “up”, “down”, “left”, “right”, and so on are the directions or location relationships shown in the accompanying figures, which are only intended to describe the present application conveniently and simplify the description, but not to indicate or imply that an indicated device or component must have specific locations or be constructed and manipulated according to specific locations; therefore, these terms shouldn't be considered as any limitation to the present application. The terms “first” and “second” are only used for the convenience of description, and cannot be understood as indicating or implying relative importance or implicitly indicating the number of technical features. “Multiple” means two or more, unless otherwise clearly and specifically defined.

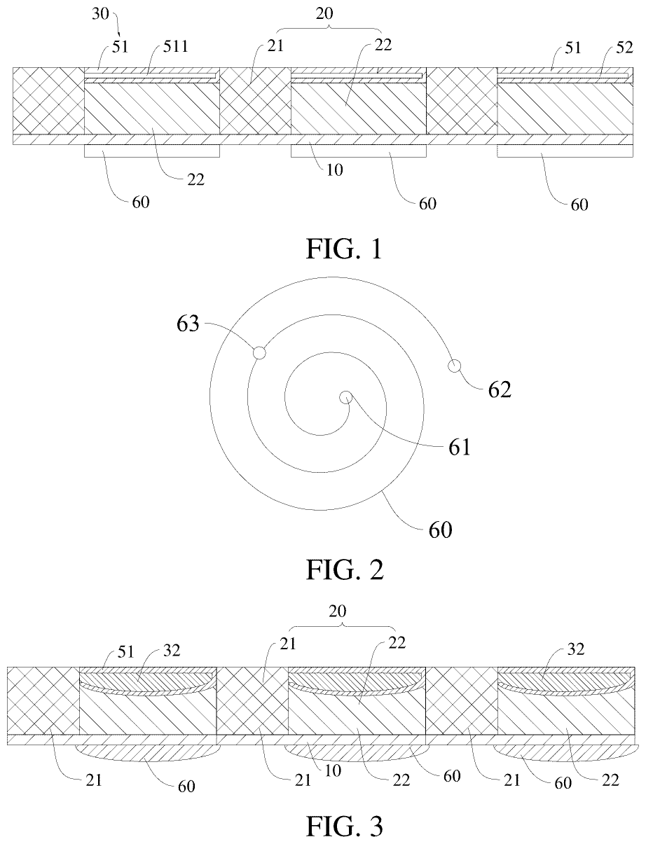

As shown in FIGS. 1 to 3, an embodiment of the present application provides a display module and an electronic paper having the same.

The display module includes a base layer 10, a color film layer 20 and a color adjustment assembly 30.

The base layer 10 is made of an opaque material to prevent light leakage.

The color film layer 20 is laid flat on the base layer 10, and the base layer 10 provides support for the color film layer 20. The color adjustment assembly 30 is connected to the color film layer 20.

As shown in FIGS. 1 to 3, the color film layer 20 includes a black matrix layer 21 and a plurality of color resistant units 22 arranged on the base layer 10. It can be understood that the black matrix layer 21 is also made of opaque material. The black matrix layer 21 is provided with a plurality of positioning holes 211, and the positioning holes 211 are spaced and arranged in an array. A color resistant unit 22 is arranged in each positioning hole 211, and at least two color resistant units 22 have different colors. Any color resistant unit 22 is correspondingly provided with one color adjustment assembly 30, and each color adjustment assembly 30 is used to adjust the display chromaticity of each color resistant unit 22 to the external environment.

As shown in FIGS. 1 to 3, the display chromaticity represents the hue and purity displayed by the color resistant unit 22. The display chromaticity of the color resistant unit 22 seen by the human eye can be adjusted by the color adjustment assembly 30. For example, the color adjustment assembly 30 can block part of the light or block part of the display area of the chromaticity unit, so that the display chromaticity seen by the human eye can be from a pure color to a variety of intermediate gradient transition colors. The combination of the plurality of color resistant units 22 can achieve a display effect with high color reproduction and smooth gradient transition.

The color resistant unit 22 can realize the color display of the display module. The color resistant unit 22 is arranged in the positioning hole 211 disposed in the black matrix layer 21, which is conductive to improve the contrast and color separation of the display. The color resistant unit 22 generally includes three basic colors: red, green, and blue. A rich color display can be realized by combining the three basic colors.

As shown in FIGS. 1 to 3, in some embodiments, the color resistant unit 22 is optionally an opaque color resistant unit. The color resistant unit 22 is arranged to be opaque, which is conductive to improve the saturation and contrast of the color. Each color resistant unit 22 is correspondingly provided with one color adjustment assembly 30, which can adjust the display chromaticity of the color resistant unit 22 to external environment to realize dynamic color adjustment. The surface of the color resistant unit 22 is the color display surface, which is the part that can be directly seen by the human eye. The color adjustment assembly 30 adjusts the display chromaticity by controlling the area covering the color display surface. The color resistant units 22 in the electronic paper do not require a backlight source, rather than use ambient light to realize display, which greatly reduces energy consumption. By finely setting and arranging the color resistant units 22, high-resolution color display can be achieved. Through the precise control of the color adjustment assembly 30, the color resistant unit 22 can be displayed from pure color to multiple intermediate gradient transition colors, so as to improve the color reproduction and display effect.

It can be understood that the color resistant unit 22 includes a blue color resistant unit, a green color resistant unit and a red color resistant unit, and a plurality of blue color resistant units 22, a plurality of green color resistant units 22 and a plurality of red color resistant units 22 are arranged on the black matrix layer 21. Through the combination of each red color resistant unit 22, each green color resistant unit 22 and each blue color resistant unit 22, and then through the color adjustment of each color adjustment assembly 30, different colored patterns and information can be displayed externally so as to improve the display effect.

As shown in FIGS. 1 to 3, the display module provided in this embodiment includes the base layer 10, the color film layer 20 and the color adjustment assembly 30. The color film layer 20 includes the black matrix layer 21 and the plurality of color resistant units 22. Through the control and color adjustment of each color resistant unit 22 by each color adjustment assembly 30, the human eye can see the color resistant units with different display chromaticity, and finally the display module can display high color chromaticity. The display module only need to use ambient light, without backlight, to make the picture clearly displayed, which can save a lot of power consumption, and increase the display quantity of color chromaticity, and also improve the display contrast.

As shown in FIGS. 1 to 2, the opaque material of the base layer 10 can be a black plastic sheet, such as a polycarbonate, a polyethylene terephthalate, an acrylonitrile-butadiene-styrene and other black reinforced plastic sheets. It can also be a black glass plate, which is made by adding colorants such as iron oxide and cobalt oxide to the glass. Which is not limited herein, and it can be selected according to actual conditions.

As shown in FIGS. 1 to 2, in some embodiments, the color adjustment assembly 30 includes a magnetic fluid layer made of opaque material, a driving member capable of generating a magnetic field and used to control the magnetic fluid layer to move, and a controller for controlling the magnetic field strength of the driving member. The magnetic fluid layer covers the color display surface of the color resistant unit 22. The driving member drives the magnetic fluid layer to move to adjust the coverage area of the magnetic fluid layer covering the color display surface. The color display surface refers to the surface of the color resistant unit 22 that can be directly seen by the human eye when there is no magnetic fluid layer covering the color resistant unit 22. At this time, the color of the color display surface is the color of the color resistant unit 22.

As shown in FIGS. 1 to 2, it can be understood that the color of the magnetic fluid layer can be black, which can prevent light from passing through the magnetic fluid layer. When the coverage area is smaller, the display chromaticity of the color resistant unit 22 is closer to its own pure color. When the coverage area is larger, the display chromaticity becomes weaker. When the magnetic fluid layer completely covers the color resistant unit 22, the human eye sees the color of the magnetic fluid layer, that is, the black, and the human eye cannot see the color of the color resistant unit 22 itself.

As shown in FIGS. 1 to 2, optionally, each color resistant unit 22 is located in each sub-pixel, and the size of the coverage area is adjusted by moving the magnetic fluid layer, so that the shielding degree of the color resistant unit 22 in each sub-pixel can be finely controlled, so as to simulate different color depths and transitional tones, and realize a continuous gradient multi-level chromaticity display, so as to achieve a richer, more natural and realistic color display effect, to greatly improve the color reproduction ability of the electronic paper, and to expand the application field of the electronic paper.

As shown in FIG. 2, in some embodiments, the driving member is a first coil 60 formed by spirally winding a wire and in a planar shape. The first coil 60 is arranged relative to the color display surface of the color resistant unit 22. The first coil 60 is provided with a first power connection point 61 and a second power connection point 62. The first power connection point 61 and the second power connection point 62 are respectively located at the two end points of the wire, and the first power connection point 61 is located at the central position of the first coil 60. The first coil 60 can be formed by spirally winding a single wire, and the first power connection point 61 and the second power connection point 62 are respectively connected to the anode and cathode of the power supply.

As shown in FIGS. 1 to 2, optionally, the planar first coil 60 is directly opposite to the color resistant unit 22, and can be located above or below the color resistant unit 22. By increasing the current of the first coil 60, the magnetic field strength at the central axis of the first coil 60 can be enhanced. Since the magnetic fluid of the magnetic fluid layer 32 tends to the area with higher magnetic field strength, the magnetic fluid will move to the central area of the first coil 60 and gather at the central axis position of the first coil 60. Since the magnetic fluid layer 32 is in a contracted state at this time, the color resistant unit 22 is not covered by the magnetic fluid layer 32 except the central position, so that the corresponding color can be displayed.

By reducing the current or maintaining a moderate current intensity, a relatively uniform magnetic field distribution can be generated on the surface of the entire first coil 60. At this time, the magnetic force on the magnetic fluid is smaller, and it will not be concentrated in a specific area, but will be relatively evenly distributed on the surface of the entire first coil 60 and completely cover the color resistant unit 22. At this time, the sub-pixel is displayed in black.

As shown in FIGS. 1 to 2, the first coil 60 is arranged below the color resistant unit 22 to prevent the first coil 60 from blocking the light from entering the color resistant unit 22. In order to enhance the magnetic control degree of the first coil 60, the thickness of the color resistance can be reduced accordingly, or the first coil 60 can be embedded in the middle and lower part of the color resistance. Alternatively, the first coil 60 made of transparent conductive material can be used, and the first coil 60 can be directly arranged above the magnetic fluid layer 32, thus there is no need to separate the color resistant unit 22 of a certain thickness between the magnetic fluid layer 32 and the first coil 60.

As shown in FIGS. 1 to 2, the magnetic field strength can also be adjusted by controlling the spacing, radius, and number of turns of the first coil 60, so that the distribution of the magnetic fluid can be better controlled in both display states. Moreover, the first coil 60 is arranged directly opposite the chromaticity unit, which is conducive to reducing the spacing between adjacent color resistant units 22, which can increase the entire color resistance area, increase pixel density, and improve color display effect.

As shown in FIGS. 1 to 2, in some embodiments, the first coil 60 is further provided with a third power connection point 63, which is located between the first power connection point 61 and the second power connection point 62.

As shown in FIGS. 1 to 2, optionally, the third power connection point 63 is further provided in the middle part of the first coil 60 and connected to the control circuit below. When displaying black in color, the first power connection point 61 and the second power connection point 62 are connected to the anode and the cathode respectively, and the third power connection point 63 is disconnected from the control circuit below. At this time, the entire first coil 60 supplies a small current to make the magnetic field uniformly distributed.

As shown in FIGS. 1 to 2, when displaying color, the first power connection point 61 and the third power connection point 63 are connected to the anode and the cathode respectively, and the second power connection point 62 is disconnected from the control circuit below. That is, at this time, the inner ring part of the first coil 60 works, while the outer ring part of the first coil 60 does not work, and the magnetic fluid gathers at the central axis of the inner ring part of the first coil 60, while the outer ring part of the first coil 60 does not gather the magnetic fluid.

As shown in FIGS. 1 to 2, tin some embodiments, the color adjustment assembly 30 further includes a first receiving shell 51 made of transparent material and arranged relative to the color resistant unit 22. The first receiving shell 51 is provided with a first receiving cavity 511 for receiving the magnetic fluid layer 32.

As shown in FIGS. 1 to 2, optionally, the shape of the first receiving shell 51 is adapted to the cross-sectional shape of the positioning hole 211, so that the first receiving shell 51 can be placed in the positioning hole 211 and positioned through the positioning hole 211. The first coil 60 can control the magnetic fluid layer 32 to gather or expand in the first receiving cavity 511 through the change of its own magnetic field strength, so as to adjust the size of the coverage area.

Optionally, the first receiving shell 51 made of transparent material is used to protect and control the magnetic fluid layer 32 to move, while ensuring that light can pass through the first receiving shell 51 to reach the color display surface of the color resistant unit 22.

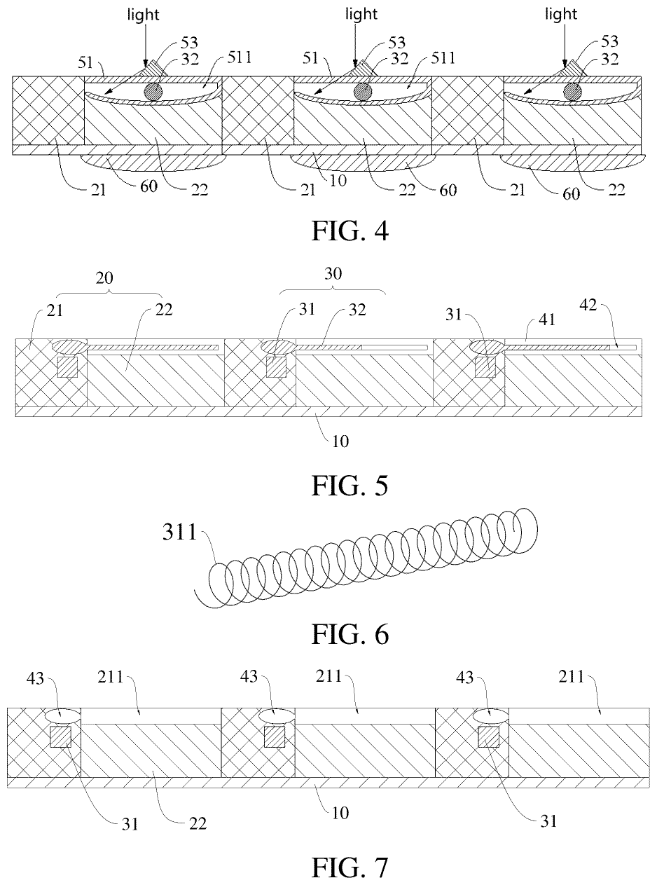

As shown in FIGS. 3 and 4, in some embodiments, the first receiving shell 51 protrudes toward the color resistant unit 22 and the color resistant unit 22 is recessed in the direction away from the first receiving cavity 511. The first coil 60 is a recessed first coil 60 and the recessed direction of the first coil 60 is the same as the recessed direction of the color resistant unit 22.

As shown in FIGS. 3 and 4, optionally, the surface of the first receiving shell 51 facing the color resistant unit 22 protrudes toward the color resistant unit 22, so that when the color display is in color, the central axis area of the first receiving cavity 511 has a larger space for receiving the magnetic fluid, which can reduce the gathering area of the magnetic fluid layer 32 and improve the color display effect.

As shown in FIGS. 3 and 4, since the color display surface of the color resistant unit 22 is an arc surface, its color display area is also larger, which improves the color display effect. The first coil 60 is recessed, and the central position of the spiral of the first coil 60 is lower than the edge position of the spiral of the first coil 60. The magnetic field is gathered at the central position, so as to improve the magnetic control ability of the magnetic fluid layer 32.

As shown in FIGS. 3 and 4, in some embodiments, the color adjustment assembly 30 further includes a reflective layer 53 disposed on the first receiving shell 51. The reflective layer 53 is used to reflect external light to the color resistor unit 22. Optionally, the cross-sectional shape of the reflective layer 53 is triangular.

As shown in FIGS. 3 and 4, optionally, the reflective layer 53 is located at the central position of the color resistant unit 22, and this position is the position where the magnetic fluid is gathered, so that the reflective layer 53 does not occupy the additional light-entering area of the color resistant unit 22. The outer surface of the reflective layer 53 can reflect more ambient light to the color resistant unit 22. When displaying in color, the light absorbed by the gathered black magnetic fluid balls can be reduced to allow more light to irradiate the color resistant unit 22 to improve the color display effect.

As shown in FIGS. 3 and 4, it can be understood that the magnetic field strength of the first coil 60 is increased to make the magnetic fluid layer 32 gather into a spherical shape in the first receiving cavity 511.

As shown in FIGS. 5 to 7, in some embodiments, the driving member is an electromagnet 31 located in the black matrix layer 21. The second coil 311 of the electromagnet 31 is spirally wound along the circumference of the fixed axis and extends along the axial direction of the fixed axis. The axial direction of the fixed axis is parallel to the base layer 10. The black matrix layer 21 is provided with a receiving hole 43 at the position corresponding to the driving member. A part of the magnetic fluid layer 32 is stored in the receiving hole 43, and another part of the magnetic fluid layer 32 covers the color resistant unit 22. The driving member drives the magnetic fluid layer 32 to flow from the receiving hole 43 to the color resistant unit 22, or drives the magnetic fluid layer 32 to flow from the color resistant unit 22 into the receiving hole 43.

As shown in FIGS. 5 to 7, optionally, the second coil 311 of the electromagnet 31 is in the shape of a spiral tube. The first and last ends of the spiral tube-shaped second coil 311 can be connected to the control circuit on the array substrate below.

As shown in FIGS. 5 to 7, it can be understood that by changing the direction of the current, the second coil 311 of the same electromagnet 31 can generate magnetic fields in opposite directions under different conditions, thereby attracting or repelling the magnetic fluid in the receiving hole 43, so as to adjust the area of the magnetic fluid layer 32 covering the color resistant unit 22. The area of the magnetic fluid layer 32 covering the color resistant unit 22 can also be adjusted by changing the current intensity to control the magnetic strength of the electromagnet 31.

As shown in FIGS. 5 to 7, in some embodiments, the color adjustment assembly 30 also includes a second receiving shell 41 made of a transparent material, the second receiving shell 41 covers the color resistant unit 22 and is provided with a second receiving cavity 42 for receiving the magnetic fluid layer 32, and the second receiving cavity 42 is connected to the receiving hole 43.

As shown in FIGS. 5 to 7, by matching the shape of the second receiving shell 41 with the cross-sectional shape of the positioning hole 211, the second receiving shell 41 can be placed in the positioning hole 211 and positioned through the positioning hole 211. The electromagnet 31 can control the magnetic fluid to flow from the receiving hole 43 into the second receiving cavity 42, or from the second receiving cavity 42 into the receiving hole 43 through the change of its own magnetic field strength, so as to adjust the size of the coverage area.

Optionally, the second receiving shell 41 made of transparent material is used to protect and control the movement of the magnetic fluid layer 32, while ensuring that light can pass through the second receiving shell 41 to reach the color display surface of the color resistant unit 22.

As shown in FIGS. 5 to 7, the shape of the second receiving shell 41 is matched with the cross-sectional shape of the positioning hole 211, which not only simplifies the assembly process, but also ensures the precise positioning of each color adjustment assembly 30. The connection between the second receiving cavity 42 and the receiving hole 43 provides a channel for the flow of the magnetic fluid, so that the electromagnet 31 can accurately control the distribution of the magnetic fluid by changing the magnetic field strength, thereby changing the area of the magnetic fluid layer 32, thereby realizing fine adjustment of the display chromaticity of the color resistant unit 22, while protecting the magnetic fluid from the influence of the external environment, therefore the stability and durability of the display module are improved.

Optionally, the magnetic fluid material of the magnetic fluid layer 32 can be an iron powder-based magnetic fluid, and the magnetic fluid layer 32 is obtained by mixing iron powder particles in a carrier liquid. The carrier liquid can be mineral oil, silicone oil, etc., and has the characteristics of being opaque and presenting black or dark gray. The iron powder particles are distributed in the carrier liquid, so that the flow characteristics of the magnetic fluid layer 32 can be changed under the action of an external magnetic field.

Optionally, the magnetic field strength of the electromagnet 31 can be controlled by a controller to realize the adjustment of the coverage area. That is, the controller can accurately adjust the magnetic field strength generated by the electromagnet 31 by changing the magnitude and direction of the current applied to the electromagnet 31. When the magnetic field strength increases, the magnetic fluid layer 32 will be subjected to a stronger magnetic force and will be attracted from the receiving hole 43 to the surrounding of the electromagnet 31, thereby reducing the area covered on the color display surface of the color resistant unit 22. On the contrary, when the magnetic field strength decreases, the magnetic fluid layer 32 will flow from the surrounding of the electromagnet 31 to the color display surface of the color resistant unit 22 under the action of gravity and surface tension, thereby increasing the coverage area.

As shown in FIGS. 5 to 7, in some embodiments, the receiving hole 43 is disposed on the hole wall of the positioning hole 211 and is located above the color display surface.

Optionally, the height of the color resistant unit 22 is less than the hole depth of the positioning hole 211, and the magnetic fluid layer 32 and the color resistant unit 22 can be completely received in the positioning hole 211. The height of the receiving hole 43 is slightly higher than the height of the color display surface of the color resistant unit 22, so as to facilitate the magnetic fluid to flow out of the receiving hole 43. At the same time, the magnetic fluid can also flow into the color resistant unit 22 and be stored in the receiving hole 43 under the action of the electromagnet 31.

Optionally, the transparent material can also be a transparent glass, or other transparent materials, such as:

Polycarbonate, which has high transparency, good impact resistance and heat resistance, and is often used as a transparent part of an electronic device;

Polymethyl methacrylate, which has excellent transparency and weather resistance, the Polymethyl methacrylate is lighter than the glass and has certain flexibility; and Cycloolefin copolymer, which has high transparency, low water absorption and good chemical stability, and is suitable for precision optical part.

As shown in FIGS. 5 to 7, in some embodiments, the controller includes a control circuit and a plurality of data wires, each of the plurality of data wires is connected to the control circuit, and each data wire is electrically connected to each electromagnet 31.

As shown in FIGS. 5 to 7, optionally, the data wire can be an IC data wire, and the control circuit controls the magnetic field strength of each electromagnet 31 through each data wire. For example, if a certain pixel area requires 50% grayscale, the control circuit controls the data wire to transmit a signal (voltage value) to this pixel area, so that the magnetic fluid layer 32 on each sub-pixel of this pixel area blocks half of the color resistant unit 22, thus 50% grayscale in the pixel area is achieved, a display screen with multiple color depths is realized, and the display screen has good display effect.

The present application further provides an electronic paper, which includes a display module. The specific structure of the display module refers to the above embodiments. Since the electronic paper adopts all the technical solutions of all the above embodiments, it also has all the beneficial effects brought by the technical solutions of the above embodiments, which will not be repeated here.

In some embodiments, the electronic paper further includes a housing, and the display module is installed on the housing.

The above is only an optional embodiment of the present application and is not intended to limit the present application. For those skilled in the art, the present application may have various changes and variations. Any modification, equivalent replacement, improvement, etc. made within the spirit and principle of the present application shall be included in the scope of the claims of the present application.

What is claimed is:

1. A display module, comprising:
a base layer, made of opaque material;
a color film layer, arranged on the base layer; and
a color adjustment assembly, connected to the color film layer;
wherein the color film layer comprises a black matrix layer and a plurality of color resistant units arranged on the base layer, the black matrix layer is provided with a plurality of positioning holes, the plurality of color resistant units are arranged in the plurality of positioning holes, wherein at least two of the plurality of color resistant units have different colors, any one of the plurality of color resistant units is correspondingly provided with the color adjustment assembly, wherein each color adjustment assembly is respectively configured to adjust a display chromaticity of each of the plurality of color resistant units to an external environment.

2. The display module according to claim 1, wherein the color adjustment assembly comprises a magnetic fluid layer made of opaque material, a driving member capable of generating a magnetic field and configured to control the magnetic fluid layer to move, and a controller configured to control a magnetic field strength of the driving member; and the driving member drives the magnetic fluid layer to move to adjust a coverage area of the magnetic fluid layer covering the plurality of color resistant units.

3. The display module according to claim 2, wherein the driving member is a first coil formed by spirally winding a wire and in a planar shape, the first coil is arranged relative to a color display surface of one color resistant unit, the first coil is provided with a first power connection point and a second power connection point, the first power connection point and the second power connection point are respectively located at two end points of the wire, and the first power connection point is located at a central position of the first coil.

4. The display module according to claim 3, wherein the first coil is further provided with a third power connection point, and the third power connection point is located between the first power connection point and the second power connection point.

5. The display module according to claim 3, wherein the color adjustment assembly further comprises a first receiving shell made of transparent material and arranged relative to the color resistant unit, the first receiving shell is provided with a first receiving cavity configured to receive the magnetic fluid layer.

6. The display module according to claim 5, wherein the first receiving shell protrudes toward the color resistant unit and the color resistant unit is recessed in a direction away from the first receiving cavity, the first coil is recessed and a recessed direction of the first coil is the same as a recessed direction of the color resistant unit.

7. The display module according to claim 6, wherein the color adjustment assembly further comprises a reflective layer disposed on the first receiving shell, and the reflective layer is configured to reflect an external light to the color resistant unit.

8. The display module according to claim 2, wherein the driving member is an electromagnet located in the black matrix layer, the electromagnet is provided with a second coil, the second coil is spirally wound along a circumference direction of a fixed axis and extends along an axial direction of the fixed axis, the axial direction of the fixed axis is parallel to the base layer, the black matrix layer is provided with a receiving hole corresponding to a position of the driving member, a part of the magnetic fluid layer is stored in the receiving hole, and another part of the magnetic fluid layer covers the color resistant unit, and the driving member drives the magnetic fluid layer to flow from the receiving hole to the color resistant unit, or drives the magnetic fluid layer to flow from the color resistant unit into the receiving hole.

9. The display module according to claim 8, wherein the color adjustment assembly further comprises a second receiving shell made of transparent material, the second receiving shell covers the color resistant unit and is provided with a second receiving cavity configured to receive the magnetic fluid layer, and the second receiving cavity is connected to the receiving hole.

10. An electronic paper, comprising a display module; wherein the display module comprises:
a base layer, made of opaque material;
a color film layer, arranged on the base layer; and
a color adjustment assembly, connected to the color film layer;
wherein the color film layer comprises a black matrix layer and a plurality of color resistant units arranged on the base layer, the black matrix layer is provided with a plurality of positioning holes, the plurality of color resistant units are arranged in the plurality of positioning holes, wherein at least two of the plurality of color resistant units have different colors, any one of the plurality of color resistant units is correspondingly provided with the color adjustment assembly, wherein each color adjustment assembly is respectively configured to adjust a display chromaticity of each of the plurality of color resistant units to an external environment.

11. The electronic paper according to claim 10, wherein the color adjustment assembly comprises a magnetic fluid layer made of opaque material, a driving member capable of generating a magnetic field and configured to control the magnetic fluid layer to move, and a controller configured to control a magnetic field strength of the driving member; and the driving member drives the magnetic fluid layer to move to adjust a coverage area of the magnetic fluid layer covering the plurality of color resistant units.

12. The electronic paper according to claim 11, wherein the driving member is a first coil formed by spirally winding a wire and in a planar shape, the first coil is arranged relative to a color display surface of one color resistant unit, the first coil is provided with a first power connection point and a second power connection point, the first power connection point and the second power connection point are respectively located at two end points of the wire, and the first power connection point is located at a central position of the first coil.

13. The electronic paper according to claim 12, wherein the first coil is further provided with a third power connection point, and the third power connection point is located between the first power connection point and the second power connection point.

14. The electronic paper according to claim 12, wherein the color adjustment assembly further comprises a first receiving shell made of transparent material and arranged relative to the color resistant unit, the first receiving shell is provided with a first receiving cavity configured to receive the magnetic fluid layer.

15. The electronic paper according to claim 14, wherein the first receiving shell protrudes toward the color resistant unit and the color resistant unit is recessed in a direction away from the first receiving cavity, the first coil is recessed and a recessed direction of the first coil is the same as a recessed direction of the color resistant unit.

16. The electronic paper according to claim 15, wherein the color adjustment assembly further comprises a reflective layer disposed on the first receiving shell, and the reflective layer is configured to reflect an external light to the color resistant unit.

17. The electronic paper according to claim 11, wherein the driving member is an electromagnet located in the black matrix layer, the electromagnet is provided with a second coil, the second coil is spirally wound along a circumference direction of a fixed axis and extends along an axial direction of the fixed axis, the axial direction of the fixed axis is parallel to the base layer, the black matrix layer is provided with a receiving hole corresponding to a position of the driving member, a part of the magnetic fluid layer is stored in the receiving hole, and another part of the magnetic fluid layer covers the color resistant unit, and the driving member drives the magnetic fluid layer to flow from the receiving hole to the color resistant unit, or drives the magnetic fluid layer to flow from the color resistant unit into the receiving hole.

18. The display module according to claim 17, wherein the color adjustment assembly further comprises a second receiving shell made of transparent material, the second receiving shell covers the color resistant unit and is provided with a second receiving cavity configured to receive the magnetic fluid layer, and the second receiving cavity is connected to the receiving hole.
